(19) United States
(12) Patent Application Publication
(10) Pub. No.: US 2026/0200133 A1
(43) Pub. Date: Jul. 16, 2026

(54) Prefabricated component formed by reverse laying and production process therefor

(71) Applicant: Bing Zhong, Xiantao City (CN)

(72) Inventor: Bing Zhong, Xiantao City (CN)

(21) Appl. No.: 19/111,230

(22) PCT Filed: May 19, 2023
(86) PCT No.: PCT/CN2023/095196

§ 371 Date: Feb. 18, 2026

(30) Foreign Application Priority Data
Sep. 13, 2022 (CN) 202211106799.3

(51) Int. Cl. B28B 23/02; B28B 1/08; B28B 3/02; B28B 19/00; B28B 23/00

(52) U.S. Cl. CPC B28B 23/02; B28B 1/082; B28B 3/022; B28B 19/0015; B28B 19/003; B28B 19/0053; B28B 23/005

(57) ABSTRACT

A prefabricated component formed by reverse laying and a production process therefor. The prefabricated component formed by reverse laying comprises a plurality of cement-based artificial stone slabs having facings, wherein nuts are embedded in a back portion of each cement-based artificial stone slab; each nut is threadedly connected to one end portion of an anchoring connecting rod; reinforced concrete is poured on the back portion of the cement-based artificial stone slab; a main body of each anchoring connecting rod is located in the reinforced concrete; and anchoring portions is provided on the main body of the anchoring connecting rod located in the reinforced concrete. In the present invention, existing stone slabs and tiles can be completely replaced with cement-based artificial stone slabs to form facings of prefabricated components formed by reverse laying and a richer facing effect can be achieved.

### TECHNICAL FIELD

The present invention relates to the technical field of construction, in particular to a prefabricated component formed by reverse laying and a production process therefor.

### BACKGROUND TECHNOLOGY

Prefabricated construction represents a major trend in the future development of the building industry, with the core of prefabricated construction being composed of various prefabricated components. Currently, the main types of prefabricated components that do not require surface decoration are those made with reverse laying stone slabs and ceramic tiles. The existing reverse laying processes are as follows: 1. Reverse laying of stone slabs involves drilling holes in the back of stone slabs (usually over 25 mm of thickness) and bending metal wires of a certain hardness into opposing anchors with end portions at 45° to hook into the holes, to prevent the anchors from shaking, chemical adhesives are generally used for reinforcement, the prepared reverse laying stone slabs are then laid in molds, the seams are sealed, and finally, steel reinforcement frameworks are laid and concrete is poured to form reinforced concrete; and the forming principle is that the reinforced concrete will grip the anchors hooked to the stone slabs, resulting in a prefabricated component with a stone decorative surface. 2. Reverse laying of ceramic tiles involves laying tiles with grooves on the back into molds, sealing the tile seams, laying steel reinforcement frameworks, and pouring concrete, and the forming principle is that the reinforced concrete will grip the grooves on the back of the tiles, resulting in prefabricated components with tile decorative surfaces. The existing reverse laying stone and tile prefabricated components have the following issues: 1. they are not environmentally friendly, as the mining and processing of stone and the high-temperature firing of tiles are not eco-friendly processes; 2. they have poor safety; thick stone slabs can only be anchored with metal wires, which have low hanging strength and are prone to aging and degradation of chemical adhesives, leading to poor seismic resistance and a significant risk of falling; tiles rely entirely on the grip between the grooves on their back and the concrete, and the numerous seams between tiles on outdoor walls will inevitably face erosion and damage from rain, snow, ultraviolet rays, and other harmful substances, leading to alkali aging of the concrete and loss of grip; additionally, the differential expansion and contraction due to temperature differences between tiles and concrete can create more cracks, all of which can lead to loosening and falling of tiles, posing significant safety risks; 3. the production efficiency is low, and implementing reverse laying and insulation and soundproofing on multiple surfaces and angles is more difficult; currently, to implement reverse laying with insulation and soundproofing for stone slabs and tiles, the stone slabs or tiles must first be laid at the bottom of the molds, then layers of concrete structure are poured, and the concrete must be cured and grip the stone slabs or tiles before insulation materials can be laid on the surface of the cured concrete, and then the next step of concrete structure pouring can proceed, therefore, multiple pours and cures are necessary to form reverse laying prefabricated components with insulation and soundproofing functions, resulting in low production efficiency; due to the structural defects of stone and tiles themselves, only relatively simple prefabricated components can be made by reverse laying, and it is even more difficult to implement reverse laying and insulation and soundproofing on multiple surfaces and angles for more complex components such as columns, beams, and windows; and 4. currently, the non-decorative surface areas of prefabricated components can only be decorated after assembly using coatings, tiles, stone, etc., and these materials generally do not meet the basic standards of green building materials, with some even completely contrary to the concept of green building materials; at the same time, the implementation of insulation and soundproofing faces various issues such as difficult installation and poor safety.

### SUMMARY OF THE INVENTION

The object of the present invention is to provide a prefabricated component formed by reverse laying and a production process therefor to solve the problems raised in the above-mentioned background technology.

The present invention adopts following technical solutions: a production process for prefabricated components formed by reverse laying, comprising following steps of:

### S1—Preparation for Production

1st step: using cement and aggregate as main raw materials and vibration as basic slab production technology to form cement-based artificial stone slabs after curing and thickness setting, forming front faces of the artificial stone slabs into finishing layers by peeling, coating, bonding, or wrapping, embedding nuts in back portions of the cement-based artificial stone slabs, threadedly connecting the nuts to end portions of anchoring connecting rods, wherein anchoring portions thereof are any geometric shapes larger than cross-sectional areas of the anchoring connecting rods, and covering outer surfaces of the cement-based artificial stone slabs with protective films as required; and
2nd step: mold preparation: laying the cement-based artificial stone slabs flat in molds to form required sizes, and sealing seams between slabs; and

### S2—Reverse Laying Production

1st step: laying metal frames in molds where the cement-based artificial stone slabs are laid, then arranging threaded sleeves on sides of the metal frames;
2nd step: when pouring concrete, performing vibration and leveling as needed and forming reinforced concretes after curing;
3rd step: arranging main bodies of anchoring connecting rods in the reinforced concrete, providing anchoring portions on the main bodies of the anchoring connecting rods located in the reinforced concrete, wherein the anchoring portions are of any geometric shapes larger than cross-sectional areas of the anchoring connecting rods, after reinforced concrete structures formed by pouring are completely solidified, huge structural forces are formed to engage the anchoring connecting rods and the anchoring portions thereof, thereby completely fixing the cement-based artificial stone slabs and the reinforced concrete into interconnected wholes, and obtaining the prefabricated components formed by reverse laying;

Preferably, in 1st step of the preparation for production of S1, when the cement-based artificial stone slabs are ultra-high performance artificial stone slabs, raw materials of artificial stone slabs are configured according to ultra-high performance standards, and slab production technology thereof is based on basic technical means of vibration, and strong pressure and vacuuming are added as main technical means for preparation.

Preferably, in 1st step of the preparation for production of S1, inside the cement-based artificial stone slabs are provided mesh sheets.

Preferably, in 1st step of the preparation for production of S1, on the anchoring connecting rods are provided thermal insulation material layers or sound insulation material layers or composite material layers consisting of thermal insulation material layers and sound insulation material layers.

Preferably, in 1st step of the reverse laying production of S2, devices for forming through-length structural holes formed by hard pipes or soft rods, or sleeves with threaded connection for grouting are provided in the metal frames as required.

Preferably, in 2nd step of the reverse laying production of S2, before pouring concrete, the end portions of the anchoring connecting rods are threadedly connected to embedded nuts as needed; and then the concrete is poured and cured to form the reinforced concrete, and threaded mouths of the embedded nuts are located on the back portions of the reinforced concrete.

Preferably, in 2nd step of the reverse laying production of S2, before pouring concrete or initial setting of concrete, multiple embedded nuts are implanted as needed.

Preferably, the embedded nuts are double-pass nuts or wing-shaped nuts, and the threaded mouths of the embedded nuts are not higher than the back portions of the reinforced concrete.

Preferably, in 2nd step of the reverse laying production of S2, the metal frames laid are partially exposed as required when the concrete is poured, and reinforced concrete is formed after curing.

Preferably, in 2nd step of the reverse laying production of S2, spaces of sufficient thickness to lay the cement-based artificial stone slabs are reserved, and then vibrated and leveled as required, and the cement-based artificial stone slabs prepared in the preparation for production of 1st step of S1 are directly laid or connected by back screwing or by using facing suction cups to directly lay the cement-based artificial stone slabs thereon.

Preferably, in 3rd step of the reverse laying production of S2, the anchoring portions and the anchoring connecting rods are integrated structures.

The cement-based artificial stone slabs used for prefabricated component decoration in the present invention are primarily made from cement-based materials, adhering to the highest standards of ultra-high performance in the concrete field. By employing vibration, high-pressure, and vacuuming methods during slab production, the resulting slabs exhibit higher strength and better density. Additionally, during the slab manufacturing process, interconnected stainless steel mesh sheets and externally connectable nuts are embedded. Once the slabs are produced, their surfaces are treated using the same exfoliation principle as natural stone, enabling a variety of natural stone-like decorative effects. Consequently, the artificial stone slabs can fully achieve a service life exceeding a hundred years, comparable to that of natural stones. When used as a base material, the surfaces of the artificial stone slabs can achieve any desired decorative effect through wrapping, pasting, or coating and printing. The exceptional properties of ultra-high performance cement-based artificial stone slabs meet the highest standards for fire resistance, waterproofing, and corrosion resistance, effectively preventing efflorescence and water seepage. Therefore, ultra-high performance cement-based artificial stone slabs can completely replace existing stones and ceramic tiles as the reverse laying decorative surfaces of assembled prefabricated components, offering a richer array of decorative effects. Moreover, they can be used in a healthier and more durable manner than existing decorative materials such as coatings, ceramic tiles, stones, and woods, while also thoroughly addressing the common issues of environmental unfriendliness and various performance defects associated with these materials.

The ultra-high performance cement-based artificial stone slabs, produced according to ultra-high performance standards and combined with interconnected stainless steel mesh sheets within the slabs, not only enable the creation of large-format thin slabs but also ensure that the ultra-high performance cement-based artificial stone slabs possess extremely high flexural, tensile, and impact resistance, which allows them to fully withstand the impact and destructive forces generated during concrete pouring. The nuts, fully integrated with the artificial stone slabs, provide substantial screw-hanging strength, thereby completely resolving the issues associated with stone reverse laying, such as the need for thick slabs with drilled holes for anchor connections, which are heavy, have low hanging strength, and are prone to aging of chemical adhesives. It also addresses the problems with tile reverse laying, which relies solely on specially designed grooves on the back for concrete grip, leading to low connection strength, water seepage through concrete joints, and efflorescence, all of which pose significant safety risks due to loosening and detachment. The anchor connecting rods, screwed into the back of the artificial stone slabs, can clamp insulation and soundproofing materials of any type to the back of the slabs, a feature that existing stone and tile reverse laying cannot achieve. We also set anchoring portions at the end portions of the anchor connecting rods with any geometric shapes larger than the cross-sectional areas of the rods. When producing single-sided prefabricated component formed by reverse laying, we place them in the molds of the prefabricated components, directly lay the metal frames, and pour concrete. The solidified concrete will completely envelop the anchoring portions at the end of the anchor connecting rod. The powerful enveloping force of the reinforced concrete structure and the setting larger than the anchoring portions can generate a tremendous connection force for the anchor connecting rod. Therefore, the slab, fully interconnected with the anchor connecting rod, will be interlinked with the concrete structure to form a whole, thus easily achieving the triple function of insulation, soundproofing, and decoration on the single side of the prefabricated component, with extremely high safety. Based on the above principles, when reverse laying prefabricated components such as beams, columns, and windows that require multi-sided decoration, we can directly lay the slabs with clamped insulation and soundproofing materials at the bottom and sides of the mold or screw and link the slabs through long steel strips combined with anchor connecting rods, thereby easily completing multi-sided reverse laying decoration and multi-sided insulation and soundproofing functions. On the pouring surface of the prefabricated components, where existing stone and tiles are extremely difficult to decorate, we clamp insulation and soundproofing materials to the ultra-high performance cement-based artificial stone slabs through anchor connecting rods and directly lay them on the poured concrete surface by direct placement, back screwing and linking, or using decorative surface suction cups. The solidified concrete will completely grip the anchor connecting rods extending into the reinforced concrete and set larger than the diameter of the anchoring portions, thus enabling us to achieve all-around decoration and insulation and soundproofing functions for the prefabricated components. The powerful hanging forces generated by the screwing advantage on the back portions of the artificial stone slabs, the strong connection forces produced by the setting larger than the cross-sections at the end portions of the anchor connecting rods, and the easily achieved insulation and soundproofing functions through physical clamping are advantages that existing stone drilling and tile grooving cannot achieve.

At the same time, anchor connecting rods are used to screw-connect double-ended nuts, positioning the screw holes of the nuts at the back portions of the reinforced concrete, or implant wing-shaped nuts after concrete pouring, or connect them to the metal frames before pouring concrete. Once the reverse laying prefabricated components are made, the embedded nuts, fully integrated with the entire prefabricated components, can easily and flexibly screw-connect various connectors. This not only solves the installation challenges of reverse laying prefabricated components but also easily achieves insulation, soundproofing, and bidirectional decoration functions by clamping various insulation and soundproofing materials. When used as assembled prefabricated components, the embedded nuts at the back portions of the reverse laying prefabricated components can be connected or fixed to the metal frame by screwing various connectors and threading insulation and soundproofing materials, either opposite or only inside or outside the frameworks. After pouring concrete to envelop and solidify the connectors within the embedded nuts, structural walls can be directly formed, thereby replacing existing monolithic prefabricated walls and double-sided composite wall panels, and solving the problems of heavy weight, difficult installation, and the necessity of decoration, insulation, and soundproofing construction. They can replace existing composite slabs to form floor slabs, directly saving on later decoration, insulation, and soundproofing construction. When replacing existing steel, aluminum, wood, and other formworks for cast-in-place construction, the reinforced concrete structures formed by reverse laying prefabricated components can fully bear the expansion force generated during concrete pouring. As long as the connectors screwed into the embedded nuts at the back portions of the prefabricated components are enveloped by the poured concrete, the cast-in-place building can directly become a finished building with decoration, insulation, and soundproofing functions. By screwing and linking various metal connectors at the back portions of the reverse laying prefabricated components, integrated housing structures with walls and roofs can be directly assembled. When used as the enclosure system for frame structures, the embedded nuts of the reverse laying prefabricated components can be directly locked onto the framework formed by steel structures, reinforced concrete structures, wood structures, etc., by screwing various connectors, thereby directly becoming the wall and roof enclosure systems of these structures. This not only directly achieves multiple functions of structure, decoration, insulation, and soundproofing but also solves the problems of metal oxidation and corrosion, environmental unfriendliness of existing enclosure systems; the low strength and poor performance of walls formed by various lightweight block panels and existing tile surfaces; and the various defects of having to carry out decoration, insulation, and soundproofing construction. The excellent performance and the advantageous functions of screw-connection of reverse laying prefabricated components can also be used for various military barracks, box transformers, guard booths, etc., and can withstand various harsh environments.

The present invention can utilize the highest technical standards of cement concrete to configure ultra-high performance artificial stone slabs. After employing the currently challenging methods of vibration, high-pressure, and vacuuming for producing ultra-high performance concrete, it is entirely possible to bring the performance of cement-based artificial stone slabs to the limits of existing cement concrete. Once the cement-based artificial stone slabs are reverse laying decorated, they can become completely integrated with the reinforced concrete structures formed by cement-based materials, achieving a minimum of C100 grade artificial stone slabs. When used as the overall surface layer of existing primarily C30 and C40 grade reinforced concrete prefabricated component structures, it can completely block various erosion and damage to the reinforced concrete structures caused by various harmful substances such as ultraviolet rays and rainwater. Therefore, buildings assembled with prefabricated components fully protected by ultra-high performance cement-based artificial stone slabs can have a significantly improved service life compared to existing prefabricated buildings protected by decorative materials such as ceramic tiles and coatings.

The ultra-high performance cement-based artificial stone slabs of the present invention are primarily made from waste materials from natural stone processing or from miscellaneous and crushed stones that are widely found in nature that may even affect crop growth as the main materials, and industrial waste silica fume, mineral powder, fly ash and the like combined with cement as the cementitious material. The production process does not require high-temperature firing, produces no chemical odors, and the waste generated during processing can be reused or made into other building materials, thus fully achieving the highest environmental standards of zero pollution and zero emissions. The ultra-high performance cement-based artificial stone slabs, free from any harmful substances, meet the highest health requirements during use. With the addition of nanotechnology or surface nano-treatment, they can also achieve various beneficial functions such as sterilization, self-cleaning, and air purification. The ultra-high strength and durability thereof exceeds the high strength and durability standards required by green building materials. After removal, the slabs can be reprocessed into new decorative panels or crushed and re-manufactured into new products, ensuring that all aspects meet the highest standards of green building materials. By replacing stone and tile reverse laying prefabricated components with ultra-high performance cement-based artificial stone slabs, the present invention enables buildings to directly achieve highly energy-efficient green building standards upon assembly. Therefore, the present invention is an innovative technology that benefits both the nation and its people.

### BRIEF DESCRIPTION OF THE DRAWINGS

FIG. 1 is a structural schematic diagram of the present invention.

FIG. 2 is a structural schematic diagram of a prefabricated component with composite insulation and soundproofing materials in the present invention.

FIG. 3 is a schematic diagram of the present invention as a wall panel with a decorative surface applied in a building structure.

FIG. 4 is a schematic diagram of the present invention as a thicker wall panel with a decorative surface applied in a building.

FIG. 5 is a schematic diagram of a single-sided assembled floor prefabricated component in the present invention.

FIG. 6 is a schematic diagram of the present invention as a floor with a decorative surface applied in a building structure.

FIG. 7 is a schematic diagram of a single-sided assembled reverse laying prefabricated component with back connection in the present invention.

FIG. 8 is a schematic diagram of a single-sided assembled reverse laying prefabricated component with back connection and composite insulation and soundproofing materials in the present invention.

FIG. 9 is a schematic diagram of the present invention as a wall panel with a decorative surface and back connection applied in a building frame structure.

FIG. 10 is a schematic diagram of the present invention applied in a roof structure.

FIG. 11 is a schematic diagram of the present invention as a single-sided assembled reverse laying prefabricated component with back connection applied in a shear wall.

FIG. 12 is a schematic diagram of another single-sided assembled reverse laying prefabricated component with back connection in the present invention.

FIG. 13 is a schematic diagram of another single-sided assembled reverse laying prefabricated component with back connection and composite insulation and soundproofing materials in the present invention.

FIG. 14 is a schematic diagram of a double-sided assembled wall panel prefabricated component in the present invention.

FIG. 15 is a schematic diagram of the present invention applied in a wall structure.

FIG. 16 is a schematic diagram of an assembled three-sided reverse laying beam prefabricated component in the present invention.

FIG. 17 is a schematic diagram of another assembled three-sided reverse laying beam prefabricated component in the present invention.

FIG. 18 is a schematic diagram of an assembled four-sided reverse laying column prefabricated component in the present invention.

FIG. 19 is a schematic diagram of the application of the present invention in a cast-in-place frame structure.

FIG. 20 is an enlarged view of section “A” in FIG. 19.

FIG. 21 is an enlarged view of section “B” in FIG. 19.

FIG. 22 is a schematic diagram of an assembled multi-sided reverse laying wall panel prefabricated component with windows in the present invention.

FIG. 23 is a schematic diagram of an assembled multi-sided reverse laying balcony prefabricated component in the present invention.

FIG. 24 is a schematic diagram of an assembled multi-sided reverse laying corner prefabricated component in the present invention.

The markups in the drawings are indicated as follows:
1—cement-based artificial stone slab;
2—mesh sheet;
3—nut;
4—anchor connecting rod;
5—insulation material layer;
6—soundproofing material layer;
7—metal frame;
8—reinforced concrete;
9—anchoring portion;
10—threaded sleeve;
11—embedded nut;
12—through-length structural hole;
13—metal connecting device;
14—sleeve;
16—frame structure;
17—square or channel steel;
18—roof framework;
19—fixing member;
20—triangular support frame; and
21—full scaffolding.

### SPECIFIC EMBODIMENTS

The following will be combined with the accompanying drawings in the embodiments of the present invention to clearly and completely describe the technical solutions in the embodiments of the present invention. Obviously, the described embodiments are only some embodiments of the present invention, rather than all the embodiments. Based on the embodiments of the present invention, all other embodiments obtained by ordinary technicians in this field without creative work are within the scope of protection of the present invention.

### Embodiment 1

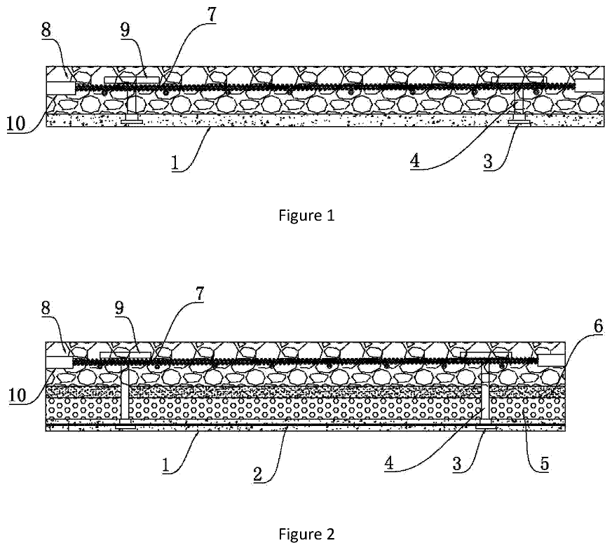

As shown in FIG. 1, when the prefabricated components are single-sided prefabricated components formed by reverse laying, a production process therefor comprises following steps:

### S1—Preparation for Production

1st step: use cement and aggregate as main raw materials and vibration as basic slab production technology to form cement-based artificial stone slabs 1 after curing and thickness setting, form front faces of the artificial stone slabs 1 into finishing layers by peeling, coating, bonding, or wrapping, embedding nuts 3 in back portions of the cement-based artificial stone slabs 1, threadedly connect the nuts to end portions of anchoring connecting rods 4, and cover outer surfaces of the cement-based artificial stone slab 1 with protective films as required; and
2nd step: mold preparation: lay a plurality of the cement-based artificial stone slabs 1 in the molds to preparing molds of required size, and seal seams between slabs; and

### S2—Reverse Laying Production

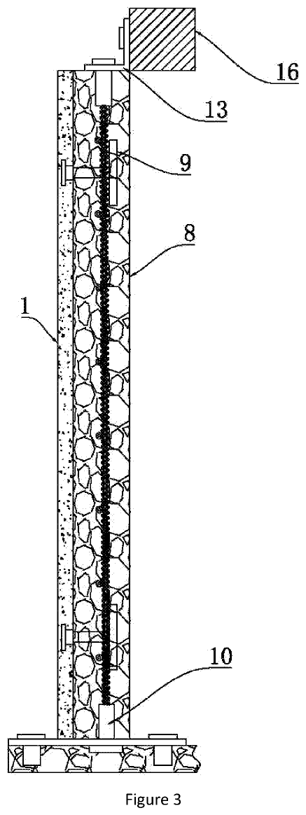

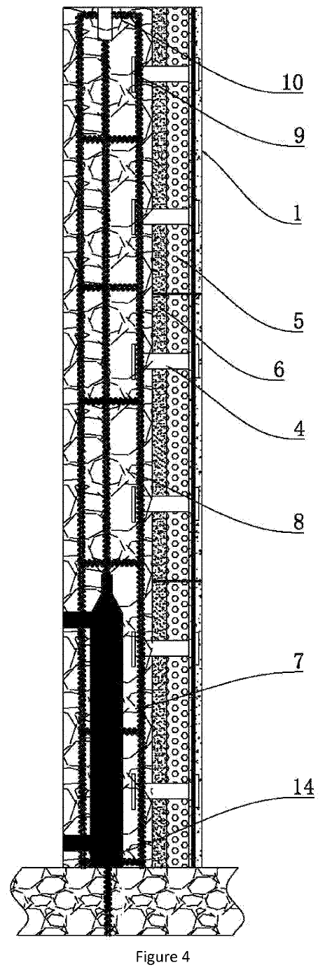

1st step: lay metal frames 7 in the molds where the cement-based artificial stone slabs 1 are laid, then arrange threaded sleeves 10 on sides of the metal frames 7;
2nd step: while pouring concrete, perform vibration and leveling as needed and forming reinforced concrete 8 after curing; and
3rd step: arrange main bodies of anchoring connecting rods 4 in the reinforced concrete 8, provide anchoring portions 9 on the main bodies of the anchoring connecting rods 4 located in the reinforced concrete 8, wherein the anchoring portions 9 are of any geometric shapes larger than cross-sectional areas of the anchoring connecting rods 4, and the anchoring portions 9 can be integrated with the anchoring connecting rods 4; and after reinforced concrete structures formed by pouring are completely solidified, huge structural forces are formed to engage the anchoring connecting rods 4 and the anchoring portions 9 thereof, thereby completely fixing the cement-based artificial stone slabs 1 and the reinforced concrete 8 into interconnected wholes, and obtain the prefabricated components formed by reverse laying;
4^{th} step: the single-sided prefabricated components formed by reverse laying can be applied in floor slabs, composite slabs, or wall panels, etc.;
5^{th} step: when the single-sided prefabricated components formed by reverse laying are used as a wall panel with a decorative surface (as shown in FIG. 3), transport them to the construction site and hoist the same onto a building structure, upper and lower end portions of the wall panel with a decorative surface are provided with threaded sleeves 10, which are fixedly connected to the upper and lower parts of a frame structure 16 by screwing corner-shaped or straight-shaped metal connecting devices 13, thus apply them to a building frame structure; and
6^{th} step: when the prefabricated components formed by reverse laying are used as a thicker single-sided wall panel component with a decorative surface (as shown in FIG. 4), after hoisting and comparison, place a groutable sleeve 14 or a through-length structural hole 12 formed by a hard pipe or soft rod extending to the outer surface of the reinforced concrete 8 over the pre-embedded steel bars at the construction site, implant some steel bars as needed, then grout or pour concrete, and complete the assembly and installation after solidification.

### Embodiment 2

As shown in FIG. 2, the present embodiment is different from embodiment 1 as follows: in the slab preparation, the cement-based artificial stone slabs 1 are ultra-high performance cement-based artificial stone slabs, the ultra-high performance cement-based artificial stone slabs are primarily made from cement and aggregate, configured according to ultra-high performance standards, and slab production technology thereof is based on the basic technique of vibration, with the addition of high-pressure and vacuuming as the main technical means; after curing and thickness determination, the ultra-high performance cement-based artificial stone slabs are formed; and the ultra-high performance cement-based artificial stone slabs are equipped with mesh sheets 2, and the anchor connecting rods 4 are threaded with insulation material layers 5 or soundproofing material layers 6, or composite material layers composed of both the insulation material layers 5 and the soundproofing material layers 6.

### Embodiment 3

As shown in FIG. 5, the present embodiment is different from embodiment 2 as follows: during the reverse laying production, when pouring concrete, the laid metal frames 7 can be partially exposed as needed, and after curing, reinforced concrete 8 is formed; the final assembled single-sided prefabricated component formed by reverse laying can be assembled composite slabs or other prefabricated components.

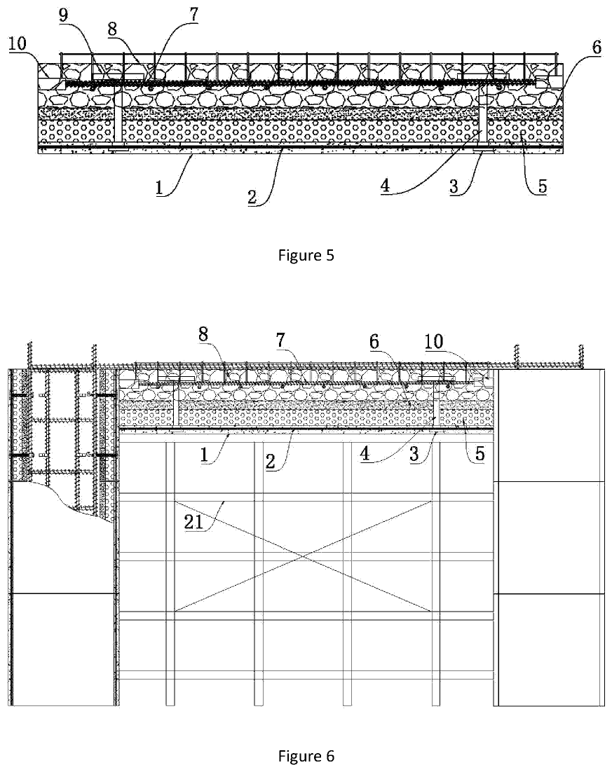

As shown in FIG. 6, when the prefabricated components are applied in a floor with a decorative surface, transport them to the construction site and lay on top of the full scaffolding by hoisting, the exposed parts of the metal frames can be threaded with steel bars, which can be tied to the steel framework of the shear wall or the steel framework of the beams and columns; they can also be connected to the upper part of the frame structure by screwing corner-shaped or straight-shaped metal connecting devices 13; finally, grout is injected for fixing, thereby making a multifunctional floor structure.

### Embodiment 4

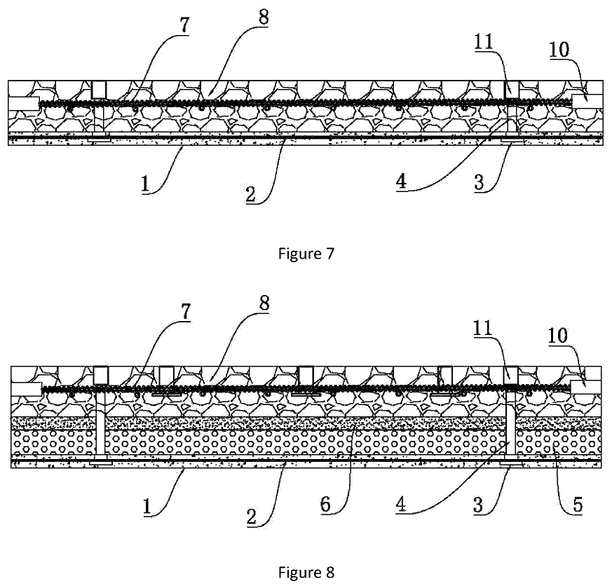

As shown in FIG. 7, when the prefabricated components are single-sided prefabricated components formed by reverse laying, and the embedded nuts 11 are double-ended nuts or wing-shaped nuts; and a production process therefor comprises following steps:

### S1—Preparation for Production

1st step: use cement and aggregate as main raw materials and vibration as basic slab production technology to form cement-based artificial stone slabs 1 after curing and thickness setting, form front faces of the artificial stone slabs 1 into finishing layers by peeling, coating, bonding, or wrapping, embed nuts 3 in back portions of the cement-based artificial stone slabs 1, threadedly connect the nuts to end portions of anchoring connecting rods 4, and cover outer surfaces of the cement-based artificial stone slabs 1 with protective films as required; and
2nd step: mold preparation: lay the cement-based artificial stone slabs 1 flat in molds to form required sizes and seal seams between slabs; and

### S2—Reverse Laying Production

1st step: lay metal frames 7 in molds where the cement-based artificial stone slabs 1 are laid, then arrange threaded sleeves 10 on sides of the metal frames 7, wherein the threaded sleeves 10 can be connected with lifting ring threads to facilitate lifting
2nd step: before pouring concrete, threadedly connect end portions of embedded nuts 11 to another end portions of the anchor connecting rods 4, seal another end portions of the embedded nuts, then pour concrete, before the initial setting of the concrete, implant multiple embedded nuts 11 as needed to increase the density of the embedded nuts 11; and form the reinforced concrete 8 after curing, wherein the threaded mouths of the embedded nuts 11 are located on the back portions of the reinforced concrete 8;
3rd step: arrange main bodies of anchoring connecting rods 4 in the reinforced concrete 8; and after reinforced concrete structures formed by pouring are completely solidified, huge structural forces are formed to engage the anchoring connecting rods 4 and the embedded nuts 11, thereby completely fixing the cement-based artificial stone slabs 1, the reinforced concrete 8, and the embedded nuts 11 into interconnected wholes, and obtain the prefabricated components formed by reverse laying;

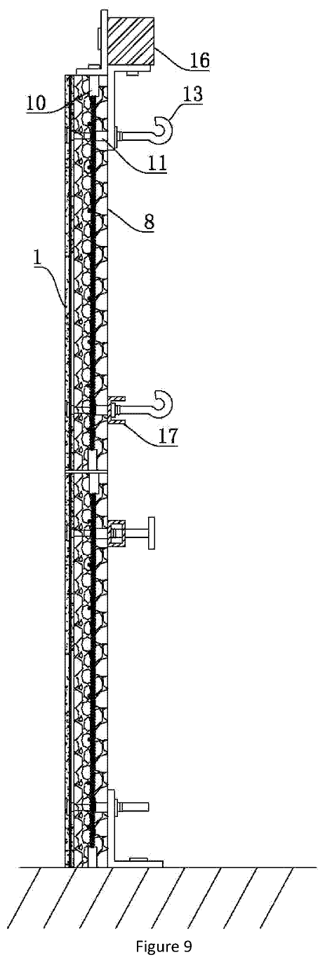

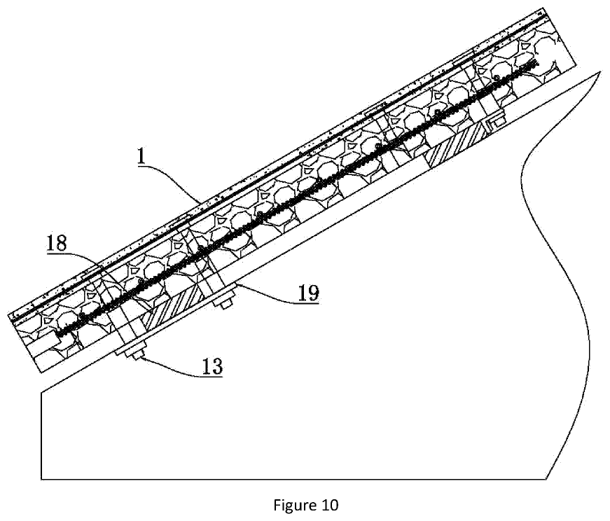

4^{th} step: as shown in FIG. 9, when the prefabricated components are used as a wall panel with a decorative surface, transport them to the construction site and hoisted onto the building structure, threaded mouths of the embedded nuts 11 at the back portions of the wall panel with a decorative surface are screwed to threaded end portions of the connectors 13, main bodies of the connectors 13 are fixedly connected to the upper, middle, and lower parts of the frame structure 16, the connectors 13 are connecting rods with threaded end portions at end portions, which can be screwed to square steels, channel steels 17, etc., thus applying to the building frame structure, between the wall panel with a decorative surface and the frame structure 16 can be provided insulation material layers 5 or soundproofing material layers 6 or composite material layers composed of both the insulation material layers 5 and the soundproofing material layers 6, and the cavity between them can also be filled with foamed cement, etc.; and
5^{th} step: as shown in FIG. 10, when the prefabricated components are applied to a roof, the multifunctional single-sided assembled reverse laying prefabricated components with back connection are hoisted onto the roof framework, threaded end portions of the connectors 13 pass through corner-shaped or straight-shaped fixing members 19, and the prefabricated components are sequentially screwed and fixed onto the roof framework 18, thus applying them to the steel structure roof.

### Embodiment 5

As shown in FIG. 8, the present embodiment is different from embodiment 4 as follows: in the slab preparation, the anchor connecting rods 4 are threaded with insulation material layers 5 or soundproofing material layers 6 or composite material layers composed of both the insulation material layers 5 and the soundproofing material layers 6.

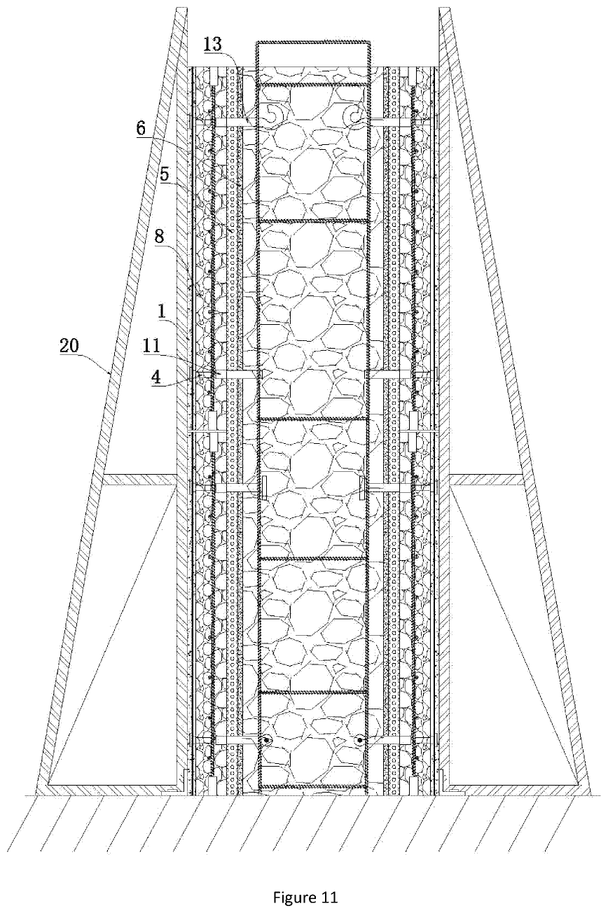

As shown in FIG. 11, when the multifunctional single-sided assembled reverse laying prefabricated components with back connection are applied to a shear wall, the threaded end portions of the embedded nuts 11 at the back portions of the prefabricated components can be screwed to threaded end portions of the connectors 13, and the connectors 13 are provided with any geometric shapes larger than the cross-sectional areas of end portions thereof; or after the prefabricated components are hoisted to the sides of the steel framework at the construction site, threaded end portions of the connectors 13 are screwed, and the connectors 13 are threaded with insulation material layers 5 or soundproofing material layers 6 or composite material layers composed of both the insulation material layers 5 and the soundproofing material layers 6. Then, triangular support frames are set up on the outside of the prefabricated components for reinforcement to prevent tilting; corner connectors can also be set up at bottom end portions of the prefabricated components for reinforcement, finally, reinforced concrete is poured between the two opposing wall panels with decorative surfaces, and main bodies of the connectors 13 are located within the reinforced concrete, after the solidified reinforced concrete grips the two prefabricated components and the connectors 13, a shear wall or wall cast-in-place structure with decoration, insulation, and soundproofing functions is obtained, or a cast-in-place shear wall that replaces the formwork and eliminates the need for decoration, insulation, and soundproofing is obtained.

### Embodiment 6

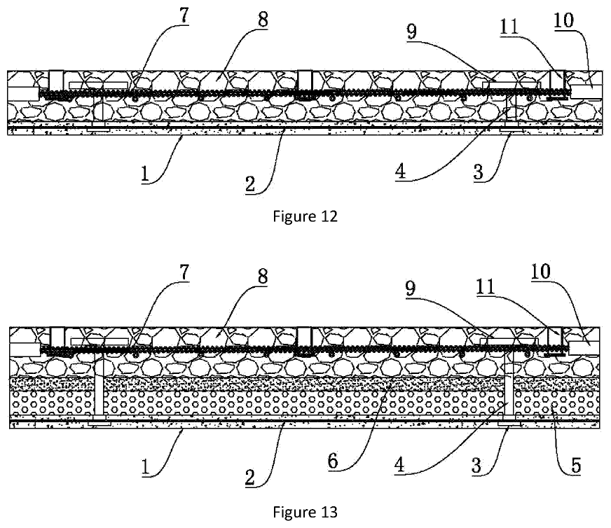

As shown in FIG. 12, when the prefabricated component is a single-sided prefabricated component formed by reverse laying, the cement-based artificial stone slab 1 is an ultra-high performance cement-based artificial stone slab, and the embedded nuts 11 are double-ended nuts or a wing-shaped nuts; and a production process therefor comprises following steps:

### S1—Preparation for Production

1st step: according to ultra-high performance standards, use cement and aggregate as main raw materials and vibration, strong pressure and vacuuming as basic slab production technology to form ultra-high performance cement-based artificial stone slabs after curing and thickness setting, form front faces of the ultra-high performance cement-based artificial stone slabs into finishing layers by peeling, coating, bonding, or wrapping, arrange mesh sheets 2 in the ultra-high performance cement-based artificial stone slabs, embed nuts 3 in back portions of the cement-based artificial stone slabs, threadedly connecting the nuts 3 to end portions of anchoring connecting rods 4, and cover outer surfaces of the ultra-high performance cement-based artificial stone slabs with protective films as required; and
2nd step: mold preparation: lay the ultra-high performance cement-based artificial stone slabs flat in molds to form required sizes, and seal seams between slabs; and

### S2—Reverse Laying Production

1st step: lay metal frames 7 in molds where the ultra-high performance cement-based artificial stone slabs are laid, then arrange threaded sleeves 10 on sides of the metal frames 7,
2nd step: before pouring concrete, connect wing-shaped nuts to the metal frames 7, seal threaded mouths of the wing-shaped nuts, then pour concrete, implant multiple wing-shaped nuts as needed to increase the density of the wing-shaped nuts before the initial setting of the concrete, and form reinforced concrete 8 after curing, wherein the wing-shaped nuts are located on the back portions of the reinforced concrete 8; and
3rd step: arrange main bodies of anchoring connecting rods 4 in the reinforced concrete 8, provide anchoring portions 9 on the main bodies of the anchoring connecting rods 4 located in the reinforced concrete 8, wherein the anchoring portions 9 are of any geometric shapes larger than cross-sectional areas of the anchoring connecting rods 4, and the anchoring portions 9 can be integrated with the anchoring connecting rods 4; and after reinforced concrete structures formed by pouring are completely solidified, huge structural forces are formed to engage the anchoring connecting rods 4, the anchoring portions 9 thereof, and the embedded nuts 11, thereby completely fixing the ultra-performance cement-based artificial stone slabs 1 and the reinforced concrete 8 into interconnected wholes, and obtain the multifunctional single-sided assembled reverse laying prefabricated components with back connection.

### Embodiment 7

As shown in FIG. 13, the present embodiment is different from embodiment 6, in the slab preparation, the anchor connecting rods 4 are threaded with insulation material layers 5 or soundproofing material layers 6 or composite material layers composed of both the insulation material layers 5 and the soundproofing material layers 6.

### Embodiment 8

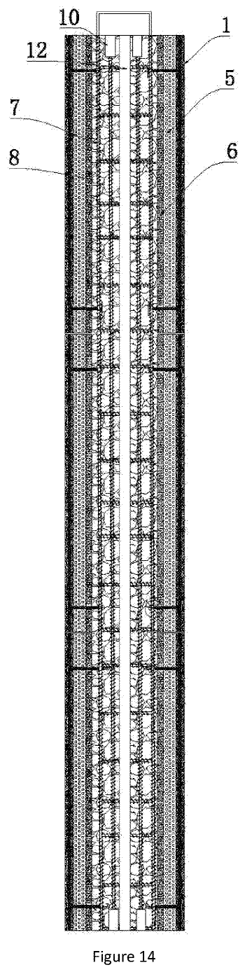

As shown in FIG. 14, when the prefabricated components are double-sided assembled reverse laying prefabricated components, the cement-based artificial stone slabs 1 are ultra-high performance cement-based artificial stone slabs; and a production process therefor comprises following steps:

### S1—Preparation for Production

1st step: same as embodiment 2; and
2nd step: mold preparation: lay the ultra-high performance cement-based artificial stone slabs flat in molds to form required sizes, and seal seams between the slabs; and

### S2—Reverse Laying Production

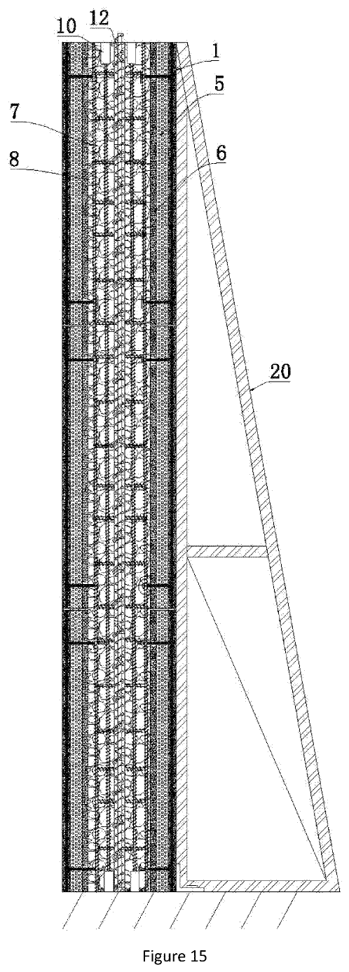

1st step: lay the metal frames 7 in the molds with the ultra-high performance cement-based artificial stone slabs, set threaded sleeves 10 on the sides of the metal frames 7, and also arrange through-length structural holes 12 formed by hard pipes or soft rods in the metal frames 7, while pre-embedding pipelines as needed;
2nd step: when pouring concrete, partially expose the metal frames on the sides as needed, and reserving spaces for laying the ultra-high performance cement-based artificial stone slabs with composite insulation material layers 5 or soundproofing material layers 6 or composite material layers composed of both the insulation material layers 5 and the soundproofing material layers 6, then vibrate and level as needed;
3rd step: lay the ultra-high performance cement-based artificial stone slabs prepared in 1st step of S1 with composite insulation material layers 5 or soundproofing material layers 6 or composite material layers composed of both the insulation material layers 5 and the soundproofing material layers 6 directly on top by direct placement or back screwing and linking or using decorative surface suction cups, and form the decorative surface by forward layering;
4^{th} step: arrange main bodies of the anchor connecting rods 4 to be located within the reinforced concrete 8, and set anchoring portions 9 at another end portions of the anchor connecting rods 4, wherein the anchoring portions 9 can be any geometric shapes larger than the cross-sectional areas of the anchor connecting rods 4 and can be integrated with the anchor connecting rods 4; at the same time, seal the seams between the slabs;
5^{th} step: after the poured reinforced concrete structure has completely solidified, form the immense structural forces to grip the anchor connecting rods 4 and anchoring portions 9 extending into the reinforced concrete, thereby fully integrating the ultra-high performance cement-based artificial stone slabs and the reinforced concrete 8 into interconnected wholes, thus obtain assembled reverse laying prefabricated components with double-sided decoration, insulation, and soundproofing functions; and
6^{th} step: when the assembled reverse laying prefabricated components with double-sided decoration, insulation, and soundproofing functions are applied to a wall structure (as shown in FIG. 15), transport the double-sided reverse laying assembled composite wall panel prefabricated components prepared in embodiment 4 to the construction site, then after hoisting and comparison, place the through-length structural holes 12 formed by hard pipes or soft rods extending to the outer surface of the reinforced concrete 8 over the pre-embedded steel bars at the construction site, set up triangular support frames on the outside of the double-sided reverse laying assembled composite wall panel prefabricated components for reinforcement, implant some steel bars as needed, and finally grout or pour concrete, thus obtain a multifunctional assembled composite wall panel.

### Embodiment 9

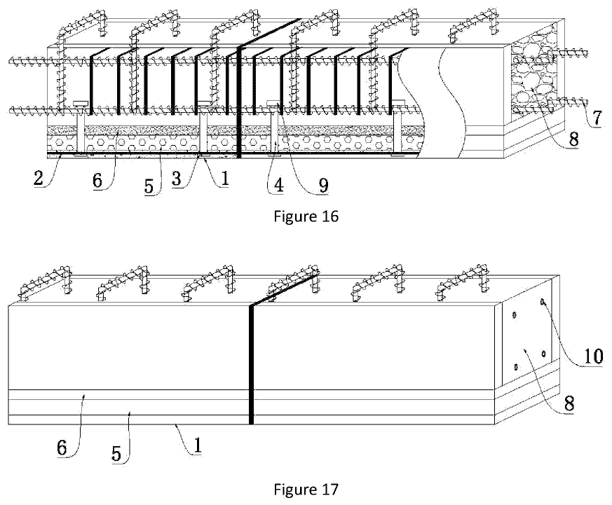

As shown in FIGS. 16-17, when the prefabricated components are three-sided reverse laying prefabricated components, the cement-based artificial stone slabs 1 are ultra-high performance cement-based artificial stone slabs, and the production process therefor comprises following steps:

### S1—Preparation for Production

1st step: same as embodiment 2; and
2nd step: mold preparation: lay the ultra-high performance cement-based artificial stone slabs flat in molds to form required sizes, and sealing seams between the ultra-high performance cement-based artificial stone slabs; and

### S2—Reverse Laying Production

1st step: lay metal frames 7 in the molds with the ultra-high performance cement-based artificial stone slabs, set threaded sleeves 10 on sides of the metal frames 7, and also set through-length structural holes 12 formed by hard pipes or soft rods in the metal frame 7, while pre-embedding pipelines as needed;
2nd step: insert chamfered cement-based artificial stone slabs 1 from inner sides of the molds and placing cement pads between the cement-based artificial stone slabs 1 and the metal frames 7 to prevent the cement-based artificial stone slabs from tilting inwards;
3rd step: when pouring concrete, vibrate and level the same as needed, and form reinforced concrete 8 after curing;
4^{th} step: arrange main bodies of the anchor connecting rods 4 to be located within the reinforced concrete 8, and set anchoring portions 9 at another end portions of the anchor connecting rods 4, wherein the anchoring portions 9 can be any geometric shapes larger than the cross-sectional areas of the anchor connecting rods 4 and can be integrated with the anchor connecting rods 4;
5^{th} step: after the poured reinforced concrete structure has completely solidified, form the immense structural forces to grip the anchor connecting rods 4 and anchoring portions 9 extending into the reinforced concrete, thereby fully integrating the ultra-high performance cement-based artificial stone slabs and the reinforced concrete 8 into interconnected wholes, thus obtain an assembled reverse-laying prefabricated component with three-sided decoration, heat preservation and sound insulation functions;
6^{th} step: the assembled reverse-laying prefabricated components with three-sided decoration, heat preservation and sound insulation functions can be prefabricated components such as prefabricated three-sided reverse-beaten beams or prefabricated three-sided reverse-beaten wall panels; and
7^{th} step: if the assembled reverse-laying prefabricated components with three-sided decoration are prefabricated load-bearing beams, parts of the metal frames can be exposed as needed.

### Embodiment 10

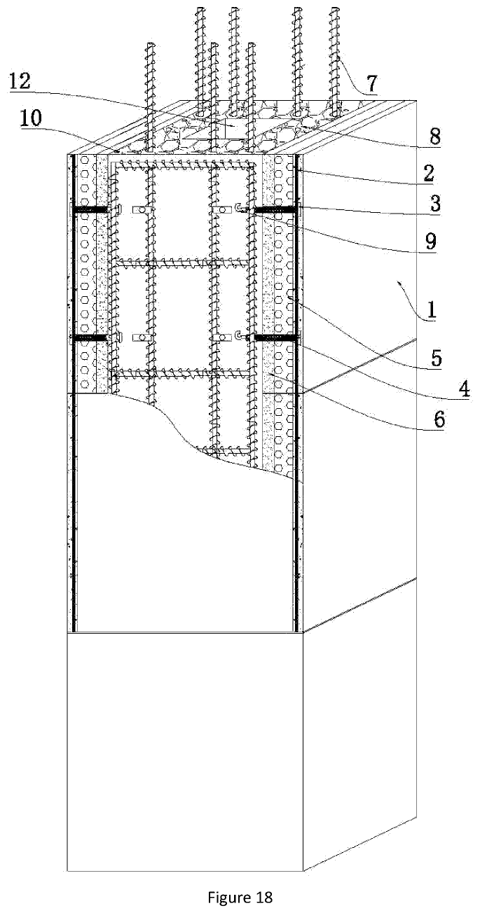

As shown in FIG. 18, when the prefabricated component are four-sided reverse laying prefabricated component, the cement-based artificial stone slabs 1 are ultra-high performance cement-based artificial stone slabs, and the metal frames 7 are steel reinforcement frameworks, and a production process therefor comprises following steps:

### S1—Preparation for Production

1st step: same as embodiment 2; and
2nd step: mold preparation: lay the ultra-high performance cement-based artificial stone slabs flat in molds to form required sizes, and seal seams between the ultra-high performance cement-based artificial stone slabs; and

### S2—Reverse Laying Production

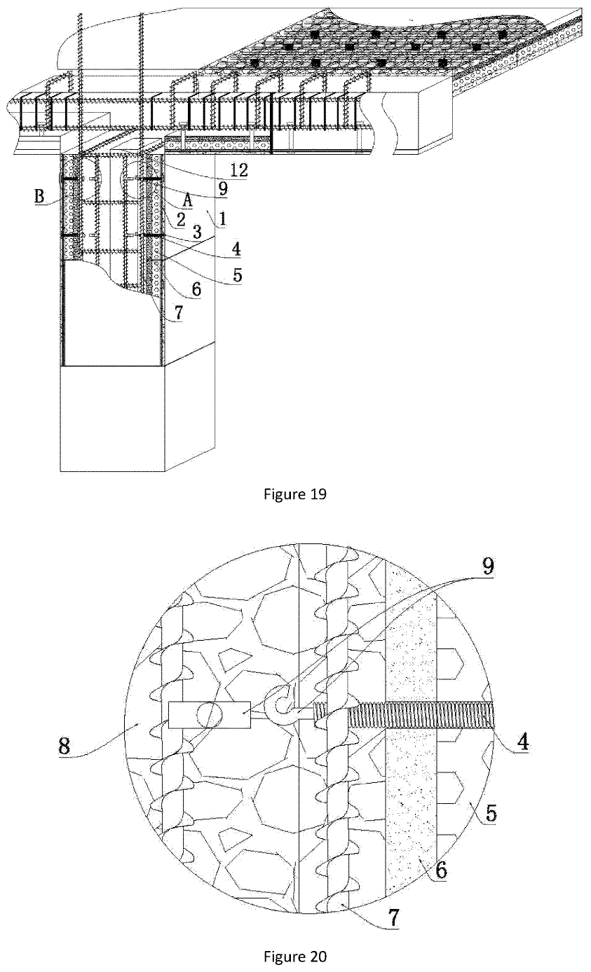

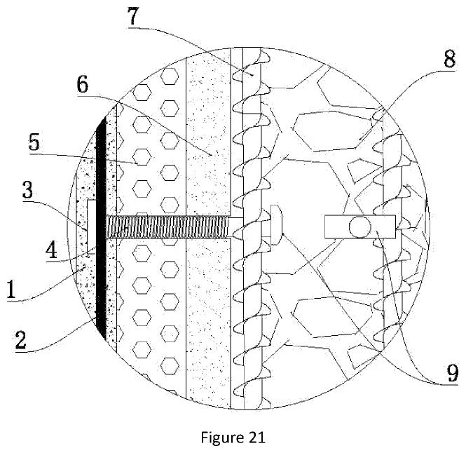

1st step: lay the ultra-high performance cement-based artificial stone slabs flat in the molds, then insert the chamfered cement-based artificial stone slabs 1 from inner sides of the molds, and then lay the steel reinforcement frames, and place cement pads between the cement-based artificial stone slabs 1 and the steel reinforcement frames to prevent the cement-based artificial stone slabs 1 from tilting inwards;
2nd step: set threaded sleeves 10 on the sides of the steel reinforcement frames, and also set through-length structural holes 12 formed by hard pipes or soft rods in the steel reinforcement frames as needed, then partially expose the steel mesh sheets and pre-embed pipelines as needed;
3rd step: when pouring concrete, reserve spaces for laying the ultra-high performance cement-based artificial stone slabs with composite insulation material layers 5 or soundproofing material layers 6 or composite material layers composed of both the insulation material layers 5 and the soundproofing material layers 6, then vibrate and level as needed; finally, lay the ultra-high performance cement-based artificial stone slabs prepared in 1st step of S1 with composite insulation material layers 5 or soundproofing material layers 6 or composite material layers composed of both the insulation material layers 5 and the soundproofing material layers 6 directly on top by direct placement or back screwing and linking or using decorative surface suction cups, form the decorative surface by forward layering, and after curing, preliminarily form a prefabricated component with four-sided decoration, insulation, and soundproofing;
4^{th} step: arrange main bodies of the anchor connecting rods 4 in the reinforced concrete 8, and provide anchoring portions 9 on the main bodies of the anchor connecting rods 4 within the reinforced concrete, wherein the anchoring portions 9 can be any geometric shapes larger than the cross-sectional areas of the anchor connecting rods 4 and can be integrated with the anchor connecting rod 4;
5^{th} step: after the poured reinforced concrete structure has completely solidified, form the immense structural forces to grip the anchor connecting rods 4 and anchoring portions 9 thereof extending into the reinforced concrete 8, thereby fully integrating the ultra-high performance cement-based artificial stone slabs and the reinforced concrete 8 into interconnected wholes, thus obtain assembled reverse laying prefabricated components with four-sided decoration, insulation, and soundproofing functions;
6^{th} step: the assembled reverse laying prefabricated components with four-sided decoration, insulation, and soundproofing functions can be assembled four-sided reverse laying columns, beams, etc.
7^{th} step: as shown in FIGS. 19-21, when the prefabricated components are applied to a cast-in-place frame structure, transport the prepared prefabricated components (columns, beams, etc.) to the construction site, then hoist the column prefabricated components to the predetermined positions according to the on-site construction layout, fix the bottom by screwing the set threaded sleeves 10 to the steel bars, then bind and enclose with the on-site steel bars before grouting; or by threading steel bars through the through-length structural holes 12 formed by hard pipes or soft rods extending to the outer surface of the reinforced concrete 8 and then grout; then hoist the beam prefabricated components between the two column prefabricated components, bind end portions of the beam prefabricated components to the exposed steel reinforcement frameworks at the top of the column prefabricated components, and pour concrete at the binding points to finally obtain the cast-in-place frame structure.

### Embodiment 11

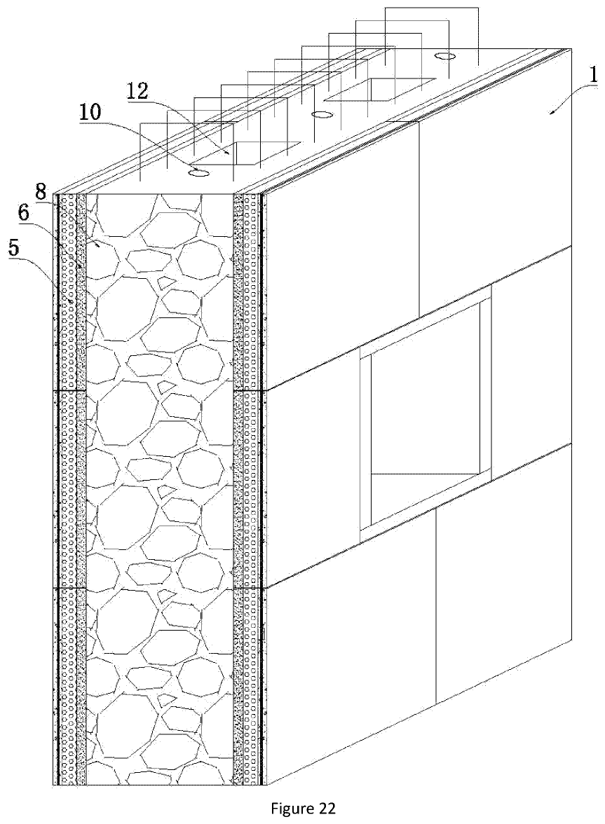

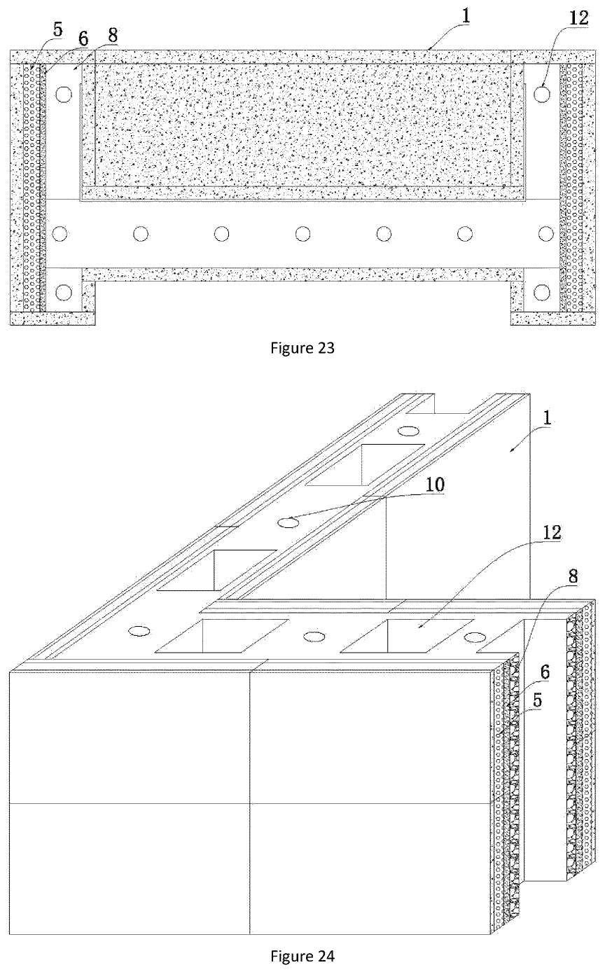

As shown in FIGS. 22-23, when the prefabricated components are multi-sided assembled reverse laying prefabricated components, the cement-based artificial stone slabs 1 are ultra-high performance cement-based artificial stone slabs, and the metal frames 7 are steel mesh sheets or steel reinforcement frameworks, and a production process therefor comprises following steps:

### S1—Preparation for Production

1st step: same as embodiment 2; and
2nd step: mold preparation: lay the ultra-high performance cement-based artificial stone slabs flat in molds to form required sizes, and seal seams between the ultra-high performance cement-based artificial stone slabs; and

### S2—Reverse Laying Production

1st step: lay the ultra-high performance cement-based artificial stone slabs flat in the molds, then insert the chamfered cement-based artificial stone slabs 1 from inner sides of the molds, and then lay the metal frames 7, and place cement pads between the cement-based artificial stone slabs 1 and the metal frames 7 to prevent the cement-based artificial stone slabs 1 from tilting inwards;
2nd step: set threaded sleeves 10 on the sides of the steel reinforcement frames, and also set through-length structural holes 12 formed by hard pipes or soft rods in the steel reinforcement frames as needed, then partially expose the steel mesh sheets and pre-embed pipelines as needed;
3rd step: ultra-high performance cement-based artificial stone slabs with chamfered corners can also be connected in series through long steel bars, specifically, placing long steel bars on the back of the ultra-high performance cement-based artificial stone slab, and then passing the anchoring connecting rods 4 through the screw holes on the long steel bars to fixing the same on the back of the ultra-high performance cement-based artificial stone slabs, wherein the long steel bar can be bent at a certain angle as needed to achieve different shape structures;
4^{th} step: when pouring concrete, reserve space for laying the ultra-high performance cement-based artificial stone slabs with composite insulation material layers 5 or soundproofing material layers 6 or composite material layers composed of both the insulation material layers 5 and the soundproofing material layers 6, then vibrate and level as needed; finally, lay the ultra-high performance cement-based artificial stone slabs prepared in 1st step of S1 with composite insulation material layers 5 or soundproofing material layer 6 or a composite material layer composed of both the insulation material layers 5 and the soundproofing material layers 6 directly on top by direct placement or back screwing and linking or using decorative surface suction cups, forming the decorative surface by forward layering;
5^{th} step: arrange main bodies of the anchor connecting rods 4 within the reinforced concrete 8, and provide anchoring portions 9 on the main body of the anchor connecting rods 4 within the reinforced concrete, wherein the anchoring portions 9 can be any geometric shapes larger than the cross-sectional areas of the anchor connecting rods 4 and can be integrated with the anchor connecting rods 4, at the same time, seal the seams between the slabs;
6^{th} step: after the poured reinforced concrete structure has completely solidified, obtain the reinforced concrete 8; the immense structural force formed will grip the anchor connecting rods 4 and its anchoring portions 9 extending into the reinforced concrete 8, thereby fully integrating the ultra-high performance cement-based artificial stone slabs and the reinforced concrete 8 into interconnected wholes, resulting in assembled multi-sided reverse laying prefabricated components; and
7^{th} step: the assembled multi-sided reverse laying prefabricated component can be assembled multi-sided reverse laying wall panels with doors and windows, balcony, prefabricated components, etc.

### Embodiment 12

As shown in FIG. 24, when the prefabricated components are multi-sided assembled reverse laying prefabricated components, the cement-based artificial stone slabs 1 are ultra-high performance cement-based artificial stone slabs, and the metal frames 7 are a steel mesh sheets or steel reinforcement frameworks; and a production process therefor comprises following steps:

### S1—Preparation for Production

1st step: same as embodiment 2; and
2nd step: mold preparation: lay the ultra-high performance cement-based artificial stone slabs flat in molds to form required sizes, and seal seams between slabs; and

### S2—Reverse Laying Production

1st step: lay the metal frames 7 on the ultra-high performance cement-based artificial stone slabs in the molds, set threaded sleeves 10 on the sides of the metal frames 7, and also set through-length structural holes 12 formed by hard pipes or soft rods in the metal frames 7 as needed, while pre-embedding pipelines as needed;
2nd step: insert the chamfered cement-based artificial stone slabs 1 from the inner sides of the molds, and place cement spacers between the ultra-high performance cement-based artificial stone slabs and the metal frames 7 to prevent the cement-based artificial stone slabs from tilting inward;
3rd step: the chamfered ultra-high performance cement-based artificial stone slabs can also be linked through long steel strips, specifically: place the long steel strips on the back of multiple ultra-high performance cement-based artificial stone slabs, then fix them to the back of the ultra-high performance cement-based artificial stone slabs by threading the anchor connecting rods 4 through the screw holes on the long steel strips, and the long steel strips can be bent to a certain angle as needed to achieve different structural shapes;
4^{th} step: when pouring concrete, reserve spaces for laying the ultra-high performance cement-based artificial stone slabs with one or a combination of composite insulation materials 5 and soundproofing materials 6, then vibrate and level as needed; finally, lay the ultra-high performance cement-based artificial stone slabs prepared in 1st step of S1 with composite insulation material layers 5 or soundproofing material layers 6 or composite material layers composed of both the insulation material layers 5 and the soundproofing material layers 6 directly on top by direct placement or back screwing and linking or using decorative surface suction cups, forming the decorative surface by forward layering;
5^{th} step: main bodies of the anchor connecting rods 4 are located within the reinforced concrete 8, and anchoring portions 9 are provided on the main bodies of the anchor connecting rods 4 within the reinforced concrete, the anchoring portions 9 can be any geometric shapes larger than the cross-sectional areas of the anchor connecting rods 4 and can be integrated with the anchor connecting rods 4, at the same time, seal the seams between the slabs;
6^{th} step: after the poured reinforced concrete structure has completely solidified, obtain the reinforced concrete 8; the immense structural force formed will grip the anchor connecting rod 4 and its anchoring portions 9 extending into the reinforced concrete 8, thereby fully integrating the ultra-high performance cement-based artificial stone slabs and the reinforced concrete 8 into an interconnected whole;
7^{th} step: then flip them at a certain angle and repeat the above steps to obtain assembled multi-sided reverse laying prefabricated components; and
8^{th} step: the assembled multi-sided reverse laying prefabricated components can be assembled multi-sided reverse laying corner wall panels, prefabricated balcony components, etc.

It will be apparent to those skilled in the art that the present invention is not limited to the details of the exemplary embodiments described above and that the present invention can be implemented in other specific forms without departing from the spirit or essential features of the present invention. Therefore, the embodiments should be considered in all respects as exemplary and non-restrictive, and the scope of the present invention is defined by the appended claims rather than the foregoing description, and it is intended that all variations that fall within the meaning and range of equivalents of the claims be included in the invention. Any reference numeral in a claim should not be considered as limiting the claim to which it relates.

1. A production process for prefabricated components formed by reverse laying, comprising following steps of:
S1—preparation for production:
1st step: using cement and aggregate as main raw materials and vibration as basic slab production technology to form cement-based artificial stone slabs (1) after curing and thickness setting, forming front faces of the artificial stone slabs (1) into finishing layers by peeling, coating, bonding, or wrapping, embedding nuts (3) in back portions of the cement-based artificial stone slabs (1), threadedly connecting the nuts (3) to end portions of anchoring connecting rods (4), and covering outer surfaces of the cement-based artificial stone slabs (1) with protective films as required; and
2nd step: mold preparation: laying the cement-based artificial stone slabs (1) flat in molds to form required sizes, and sealing seams between slabs; and
S2—reverse laying production:
1st step: laying metal frames (7) in molds where the cement-based artificial stone slabs (1) are laid, then arranging threaded sleeves on sides of the metal frames (7), and setting threaded sleeves (10) on sides of the metal frames (7);
2nd step: when pouring concrete, performing vibration and leveling as needed and forming reinforced concrete (8) after curing; and
3rd step: arranging main bodies of anchoring connecting rods (4) in the reinforced concrete (8), providing anchoring portions (9) on the main bodies of the anchoring connecting rods (4) located in the reinforced concrete (8), wherein the anchoring portions (9) are of any geometric shapes larger than cross-sectional areas of the anchoring connecting rods (4); and after reinforced concrete structures formed by pouring are completely solidified, huge structural forces are formed to engage the anchoring connecting rods (4) and the anchoring portions (9) thereof, thereby completely fixing the cement-based artificial stone slabs (1) and the reinforced concrete (8) into interconnected wholes, and obtaining the prefabricated components formed by reverse laying.

2. The production process for prefabricated components formed by reverse laying according to claim 1, wherein in 1st step of the preparation for production of S1, when the cement-based artificial stone slabs (1) are ultra-high performance artificial stone slabs, raw materials of artificial stone slabs are configured according to ultra-high performance standards, and slab production technology thereof is based on basic technical means of vibration, and strong pressure and vacuuming are added as main technical means for preparation.

3. The production process for prefabricated components formed by reverse laying according to claim 1, wherein in 1st step of the preparation for production of S1, on the anchoring connecting rods (4) are provided thermal insulation material layers (5) or sound insulation material layers (6) or composite material layers consisting of both thermal insulation material layers (5) and sound insulation material layers (6).

4. The production process for prefabricated components formed by reverse laying according to claim 1, wherein in 1st step of the reverse laying production of S2, through-length structural holes (12) or sleeves (14) capable of grouting are provided in the metal frames (7) as required.

5. The production process for prefabricated components formed by reverse laying according to claim 1, wherein in 2nd step of the reverse laying production of S2, before pouring concrete, the end portions of the anchoring connecting rods (4) are threadedly connected to embedded nuts (11) as needed; and then the concrete is poured and cured to form the reinforced concrete (8), and threaded mouths of the embedded nuts (11) are located on back portions of the reinforced concrete (8).

6. The production process for prefabricated components formed by reverse laying according to claim 1, wherein in 2nd step of the reverse laying production of S2, before concrete pouring or initial setting of concrete, embedded nuts (11) are implanted as needed.

7. The production process for prefabricated components formed by reverse laying according to claim 5, wherein the embedded nuts (11) are double-pass nuts or wing-shaped nuts.

8. The production process for prefabricated components formed by reverse laying according to claim 1, wherein in 2nd step of the reverse laying production of S2, when pouring concrete, the metal frames (7) laid are partially exposed as required, and reinforced concrete (8) is formed after curing.

9. The production process for prefabricated components formed by reverse laying according to claim 1, wherein in 2nd step of the reverse laying production of S2, when pouring concrete, spaces of sufficient thickness to lay the cement-based artificial stone slabs (1) are reserved, and then vibrated and leveled as required, and the cement-based artificial stone slabs (1) prepared in the preparation for production of 1st step of S1 are directly laid or connected by back screwing or by using facing suction cups to directly lay the cement-based artificial stone slabs (1) thereon.

10. The production process for prefabricated components formed by reverse laying according to claim 6, wherein the embedded nuts (11) are double-pass nuts or wing-shaped nuts.
